(19) United States
(12) Patent Application Publication
(10) Pub. No.: US 2014/0337464 A1
(43) Pub. Date: Nov. 13, 2014

(54) SYSTEM AND METHOD FOR INLINE HTTP NOTIFICATION

(71) Applicant: ALCATEL-LUCENT CANADA INC., Ottawa (CA)

(72) Inventors: Ian MCGARVA, Nepean (CA); Philippe BERGEON, Ottawa (CA); John FISCHER, Ottawa (CA); Steven MORIN, Ottawa (CA); Jason RUSMISEL, Ottawa (CA)

(73) Assignee: ALCATEL-LUCENT CANADA INC., Ottawa (CA)

(21) Appl. No.: 13/891,446

(22) Filed: May 10, 2013

(51) Int. Cl. H04L 29/08

(52) U.S. Cl. CPC H04L 67/02
USPC 709/217

(57) ABSTRACT

Various exemplary embodiments relate to method performed by a router. The method may include: receiving a HTTP GET request from a user device; forwarding the HTTP GET request; receiving a response to the HTTP GET request; determining whether to intercept the response based on flow selection criteria; and replacing the response with a modified response. Various exemplary embodiments relate to a router including a plurality of line cards interconnected by a backplane, the plurality of line cards receiving communication packets; and an application assurance card connected to the backplane and configured to detect application traffic flows among the communication packets, identify a HTTP session including a HTTP GET request and a matching response from among the packets; determine whether the HTTP session meets selection criteria; and modify the response to include a command to execute a script located on a notification server responsive to the HTTP session meeting the criteria.

### TECHNICAL FIELD

Various exemplary embodiments disclosed herein relate generally to communications networks.

### BACKGROUND

Network service providers often have a need to communicate information to their subscribers. For example, service providers may wish to provide information about subscriptions, billing, and network usage. Common communication methods such as e-mail and phone calls may be either ineffective or expensive. For example, email may be ignored by subscribers or viewed when the notification has become less relevant. Phone calls may require a customer service representative and also suffer from delays in providing the notification.

Despite supplying connectivity for the subscriber's internet communications, network service providers lack effective methods of contacting subscribers as they use the connection of the network service providers.

In various prior systems, a network service provider directs a user to a log-in page or other “walled garden” that the user is required to visit before logging in. Such systems may provide a negative user experience.

FIG. 1 illustrates an exemplary prior system 100 using a third-party device 170. A service provider may contract with a third-party to provide notifications to subscribers. The service provider configures router 125 to mirror traffic passing through edge router 125 to the third-party device 170. The third-party device may use the forwarded traffic to select HTTP requests and attempt to respond to the HTTP request as if it is the requested website server 160. The third-party device 170 may generate an HTTP response and send the response to the user device 110 via the edge router 125.

The system 100 has several drawbacks for providing notifications. First, the third party device 170 is in a race situation with the website server 160. In order for the third party device 170 to provide an HTTP response, it must notify the edge router 125 to reset the TCP session before the HTTP response from the website server 160 reaches the user device 110. It may be difficult for the third party server 170 to win such a race situation. Second, the third party device 170 only receives the HTTP request. The third-party device 170 is unaware of the actual response from the website server 160. Accordingly, the third-party device 170 may not be able to include the correct content in the HTTP response it generates.

### SUMMARY

In view of the foregoing, it would be desirable to provide an in-line notification system and method for providing HTTP messages to a subscriber. In particular, it would be desirable for the in-line notification system to select HTTP flows in which to include a notification based on both request and response packets. The in-line notification system may allow various types of notification formats such as web banners, overlays, and splash pages to be displayed in a web browser in order to provide a better user experience when delivering a notification to a subscriber compared to walled garden redirection. The in-line notification system may select HTTP flows in which a subscriber is viewing a top-level web page or other page suitable for a notification.

In light of the present need for an in-line notification system, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a router. The method may include: receiving a HTTP GET request from a user device; forwarding the HTTP GET request; receiving a response to the HTTP GET request; determining whether to intercept the response based on flow selection criteria; and replacing the response with a modified response including a command to execute a script stored on a notification server.

In various embodiments, the method further includes: determining whether a minimum time period has elapsed since intercepting a response; and forwarding the modified response to a user device responsive to the time period being elapsed.

In various embodiments, the flow selection criteria indicate an initial request for a top-level webpage.

In various embodiments, the flow selection criteria include characteristics of both the HTTP GET request and the response.

In various embodiments, the method is performed by an inline router.

In various embodiments, the step of replacing the response with a modified response includes adding an address of a script to the response. The address of the script may be parameterized with subscriber information provided by a policy server.

In various embodiments, the modified response indicates that a connection established by the HTTP GET request should be closed.

Various exemplary embodiments relate to a router. The router may include: a plurality of line cards interconnected by a backplane, the plurality of line cards receiving communication packets and forwarding the packets towards a destination; and an application assurance card connected to the backplane and configured to detect application traffic flows among the communication packets. The application assurance card is further configured to: identify an HTTP session including a HTTP GET request and matching response from among the packets; determine whether the HTTP session meets selection criteria; and modify the matching response to include a command to execute a script located on a notification server responsive to the HTTP session meeting the selection criteria.

In various embodiments, the application assurance card further includes a timer configured to ensure that a minimum time period has elapsed between modifying a matching response for a subscriber.

In various embodiments, the router is an edge router located between a user device that sent the HTTP GET request and a server that sent the matching response.

In various embodiments, the modified response includes a command to execute a script stored on a notification server.

In various embodiments, the application assurance card is configured to modify the matching response by adding an address of a script to the response. The address of the script may be parameterized with subscriber information provided by a policy server.

In various embodiments, selection criteria are configured to select flows for a request for a top-level webpage.

Various exemplary embodiments relate to the above described method encoded on a non-transitory machine-readable storage medium as instructions executable by a processor.

### BRIEF DESCRIPTION OF THE DRAWINGS

In order to better understand various exemplary embodiments, reference is made to the accompanying drawings, wherein:

FIG. 1 illustrates a prior art communications network;

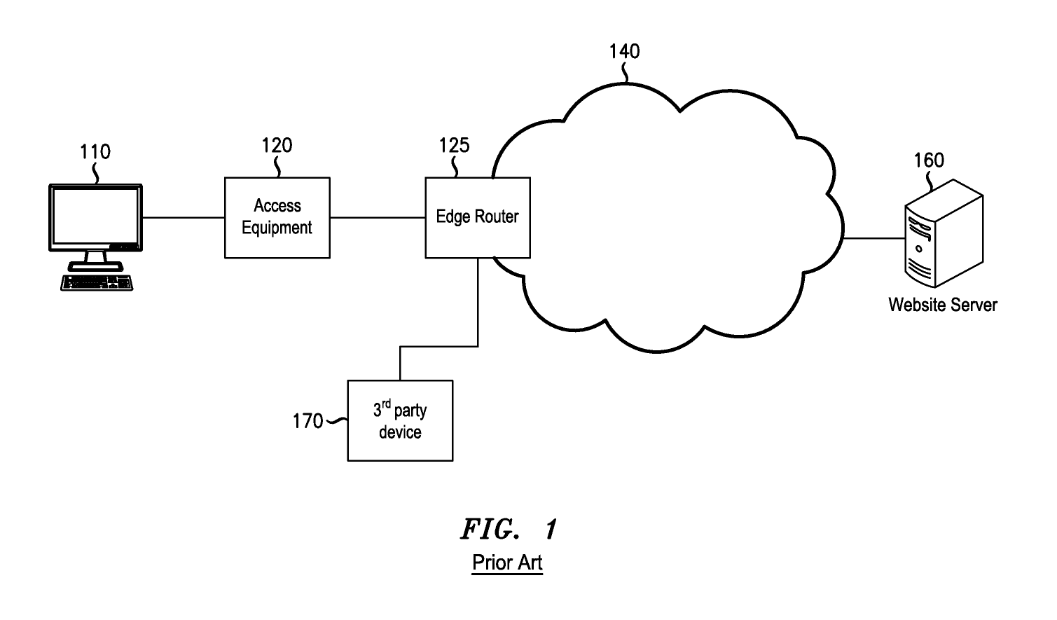

FIG. 2 illustrates an exemplary network for providing notifications;

FIG. 3 illustrates a schematic drawing of an exemplary router;

FIG. 4 illustrates a message diagram showing a message flow for providing a notification; and

FIG. 5 illustrates a flowchart illustrating an exemplary method for a router.

### DETAILED DESCRIPTION

Referring now to the drawings, in which like numerals refer to like components or steps, there are disclosed broad aspects of various exemplary embodiments.

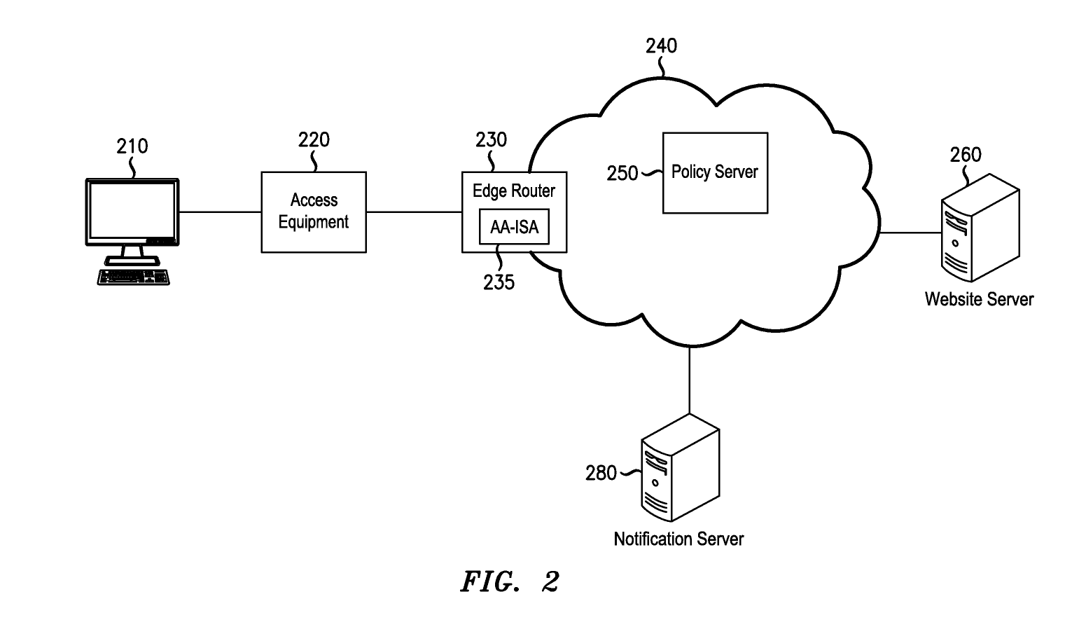

FIG. 2 illustrates an exemplary communications network 200. Communications network 200 may include a user device 210, local router 220, edge router 230, network 240, policy server 250, website server 260, and messaging or notification server 280.

User device 210 may be any device for sending and receiving information on a network. For example, user device 210 may be a personal computer, mobile device, smart phone, tablet computer, laptop computer, or personal digital assistant. User device 210 may include a processor and a memory including software for providing a web browser. User device 210 may use the web browser for displaying web pages retrieved using hypertext transfer protocol (HTTP). The web browser may be capable of executing scripts such as JavaScript.

Access equipment 220 may be any device providing network access to a user device 210. Access equipment 220 may include a Wi-Fi access point, home network router, wireless network gateway, bridge, or other device in direct communication with a user device 210. In various embodiments, a user device may be in direct contact with router 230 and access equipment 220 may not be present.

Edge router 230 may be a device providing switching and routing functionality at the edge of a service provider's core network. Edge router 230 may be connected to a plurality of local routers 220 and other intermediate devices (not shown). All traffic from user devices 210 destined for other user devices 210 or website servers 260 may travel through an edge router 230. Edge router 230 may include deep packet inspection functionality. In various embodiments, edge router 230 may include an application assurance card for performing deep packet inspection. An application assurance card may be any packet analyzer capable of analyzing the content of a packet in addition to packet header information. More specifically, an application assurance card may identify a protocol such as HTTP and parse the packet content. In various embodiments, the application assurance card may be an Application Assurance Integrated Services Adapter (AA-ISA). The edge router may use the AA-ISA card to inspect and analyze packets for providing notifications as well as other application specific features.

Edge router 230 may provide inline HTTP notifications to a user device 210. Edge router 230 may monitor HTTP flows of a user device and determine appropriate flows to intercept for notifications. The inline location of edge router 230 between the user device 210 and website server 260 may eliminate any race conditions for intercepting flows. Edge router 230 may intercept HTTP response messages from a website server 260 and replace the messages with a command to execute a script located on notification server 280. As will be described in further detail below, the script may allow the user device to display the originally requested webpage along with a notification from the service provider or other entity.

Network 240 may be one or more networks such as a service provider core network or the internet. Network 240 may include a policy server 250 that controls access to the network 240 via policy.

Policy server 250 may be a server that maintains records of subscriber information, usage, and billing. Policy server 250 may provide policy decisions to edge routers 230. In various embodiments, policy server 250 may be a Radius server or a policy and charging rules function. When a user first connects to network 240, the policy server 250 may provide authorization information to the edge router 230. The policy server 250 may also provide additional information that may be used to provide notifications to a subscriber. For example, the policy server may provide subscriber location information or subscriber usage and billing information for inclusion within a notification.

Website server 260 may be any server providing a web page accessible to user devices 210. The website server 260 use standard HTTP messages to provide a web page to a user device 210. In various embodiments, a website server 260 may provide HTTP messages indicating content should be retrieved from other servers. For example, a website server 260 may provide a redirect message based on the internet address of a user device 210.

Notification server 280 may be a server configured to incorporate notifications into a website provided by a website server 260. Notification server 280 may provide the notification to a user device 210 when the user device requests a script from the notification server. The script may instruct the user device 210 to display a webpage including a notification as well as elements from an originally requested webpage. Notification server 280 may use any technique for incorporating the notification into a webpage. For example, notification server 280 may present the notification as an overlay, banner, pop-up, or splash page.

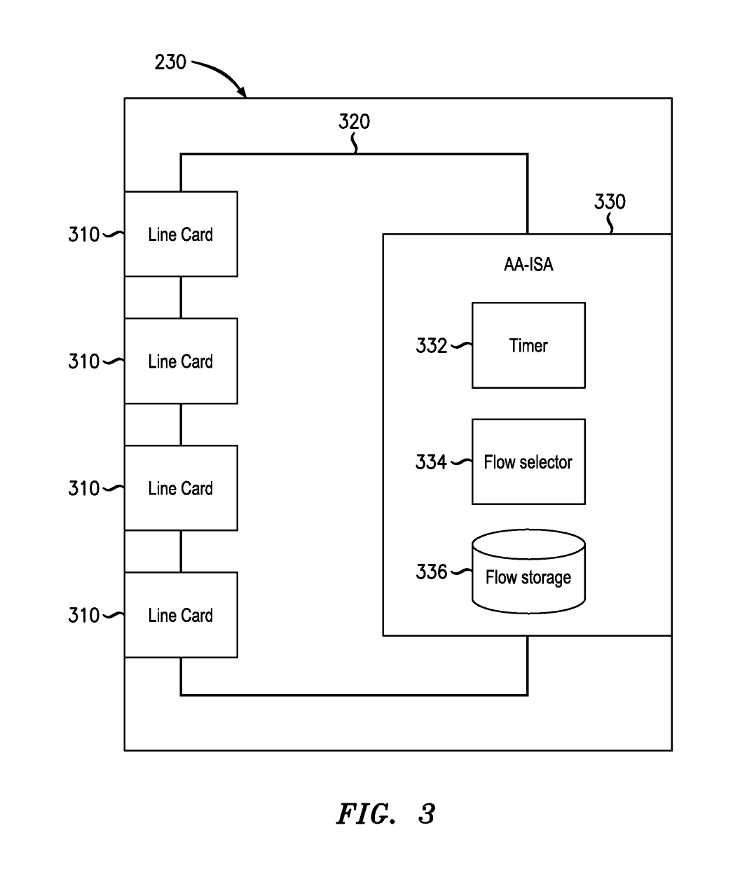

FIG. 3 illustrates an exemplary router 230. The router 230 may include a plurality of line cards 310, backplane 320, and AA-ISA card 330.

The plurality of line cards 310 may include hardware configured to receive information from a signaling medium and translate the information into a digital message. For example, line cards 310 may include a small form factor pluggable (SFP+) 10 Gb interface. Line cards 310 may receive messages sent from various network nodes such as, for example, user device 110, website server 160, and notification server 180. Line cards 310 may determine a route of a received message and forward the packet across the backplane 320 to another line card connected along the route. The other line card 310 may forward the message to another network node, such as, for example local router 220 or a router within network 240.

Backplane 320 may be a backplane, fabric switch, bus, or any other hardware configured to transmit data between components. The backplane 320 may receive messages from one line card 310 and transfer the message to another line card 310. The backplane 320 may also transfer the message to other components such as, for example, AA-ISA card 330.

AA-ISA card 330 may be an application assurance—integrated services adapter. The AA-ISA card 330 may be a hardware module that may be hot-inserted into the router 330 chassis. The AA-ISA card 330 may include a processor and a memory including instructions executable by the processor. The AA-ISA card 330 may monitor network traffic as it crosses backplane 320. The AA-ISA card 330 may provide stateful, pattern and string based identification of applications to enable dynamic per-subscriber, per-service, per-site, and per-application packet manipulation including QoS policy control. The AA-ISA card 330 may use match and action criteria to determine QoS treatment provided. The AA-ISA card 330 may provide passive monitoring and reporting, active bandwidth and flow policing, redirection, notification, and flow-based QoS re-marking to enable per-application services. The AA-ISA card 330 may provide a per-application notification service. The AA-ISA card 330 may include a timer 332, flow selector 334, and flow storage 336.

Timer 332 may include hardware or executable instructions on a machine-readable storage medium configured to enforce a minimum time between notifications to a subscriber. Timer 332 may include a memory storing a timestamp of a most recent notification for each subscriber. Timer 332 may compare the timestamp with a current time to determine whether a specified minimum time has elapsed.

Flow selector 334 may include hardware or executable instructions on a machine-readable storage medium configured to determine whether a flow meets specified selection criteria. Flow selector 334 may use a rules engine to compare selection criteria to characteristics of monitored traffic flows stored in flow storage 336. Flow selector 334 may be configured with selection criteria designed to select a request for a top-level page on a website server 160.

Flow storage 336 may include a machine-readable storage medium configured to store information regarding flows of packets. Flow storage 336 may store entire packets or critical information of packets. Flow storage 336 may be used to classify the packets into flows. For example, flow storage 336 may store all HTTP GET requests and later match the stored HTTP GET requests to received responses. Flow storage 336 may make flow information including a GET request and response available to flow selector 334 for analysis.

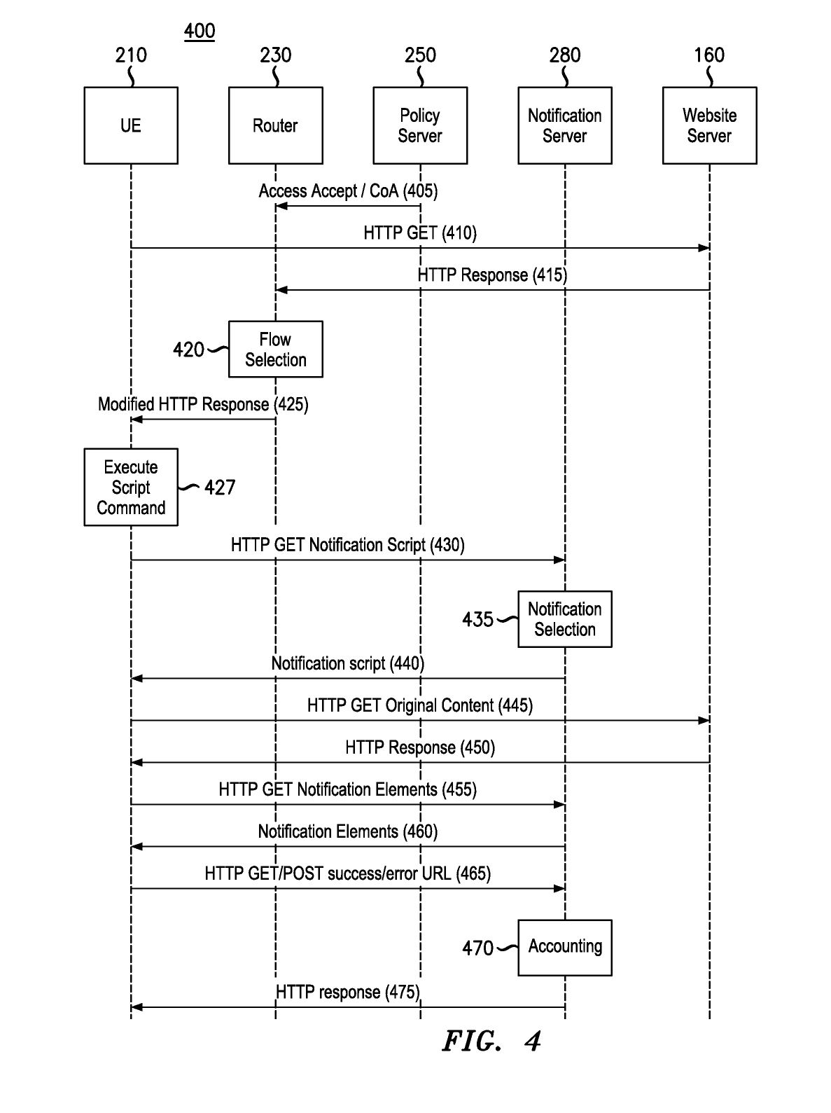

FIG. 4 illustrates a message diagram showing a method 400 of providing a notification to a user device. The method 400 may be performed by various components of exemplary network 200 including user device 210, edge router 230, policy server 250, notification server 280, and website server 260. The method 400 may begin at step 405.

At step 405, the policy server 250 may provide authorization for the user device 210 to access the network to the router 230. The policy server 250 may provide the authorization in the form of an access accept message such as a change of authorization (CoA) Radius message. As will be explained in further detail below, the authorization message may include other information available to the policy server 250 that may be used by the edge router 230 as notification parameters.

In step 410, the user device may send an HTTP GET request to a website server 260. The HTTP GET request may be a standard request used to access a webpage at a website server 260 identified by a URL. The URL may be for any website the user wants to view. The URL may be manually typed into an address bar, followed via a hyperlink, stored as a bookmark, or otherwise selected by the user. The HTTP GET request may be transmitted to the website server 260 by the edge router 230 as well as other network nodes.

The edge router 230 may use deep packet inspection to determine whether the HTTP GET request is part of a flow that is a candidate for notification. For example, the edge router may include selection criteria that are applied to HTTP GET requests to determine whether they are suitable for providing a notification. The edge router 230 may determine whether the subscriber has been selected to receive a notification. As will be discussed in further detail below, the edge router 230 may also apply selection criteria to the specific content of the HTTP GET request.

In step 415, the website server 260 may provide an HTTP response to the HTTP GET request. The method 500 may be transparent to the website server 260. Accordingly, the website server 260 may provide a standard response to the HTTP GET request based on the user device 210. The website server 260 may send the HTTP response to the user device 210 via the edge router 230.

In step 420, the edge router 230 may receive the response and perform flow selection. The edge router 230 may match the response to the HTTP GET request. The edge router 230 may then apply flow selection criteria to determine whether the HTTP flow should be intercepted for sending a notification. As will be described in further detail below, the edge router 230 may select HTTP flows that indicate a request for a landing page of a website. Providing a notification to a user viewing a landing page of a website may provide a more noticeable and less obtrusive experience for the user, resulting in effective communication. Various criteria may be used to determine whether the flow corresponds to a request for a landing page.

In step 425, the edge router 230 may replace the HTTP response from the website server 260 with a modified HTTP response. The modified HTTP response may include instructions to run a script stored on another server such as notification server 280. The instructions may identify a URL of a notification script at the notification server 280. An exemplary URL may be “http://1.1.1.1/notification.js?sub-id=12345&sub-ip=a.b.c.d>. This exemplary URL may identify a JavaScript on a notification server 180 with an IP address of 1.1.1.1. The exemplary URL may also include parameters indicating a subscriber ID and a subscriber IP address. Additional parameters associated with the subscriber may also be included in the URL. For example, the additional parameters sent from the policy server 160 in the authorization message may be included as parameters in the URL. The additional parameters may be used to provide notifications for particular scenarios such as usage based billing and geo-location based offers. The modified HTTP response may be configured to appear as if it was sent from the website server 260. Accordingly, the edge router 230 may include information such as header information from the original HTTP response in the modified HTTP response. The edge router 230 may also configure the modified HTTP response to close the initial connection between the user device 210 and the website server 260. The edge router 230 may also configure the modified HTTP response to ensure that the user device 210 knows that the HTTP request is complete, that the user device 210 does not cache the modified response; that there are not cross-domain issues with the notification server 280, and that the client's context remains intact. For example, the modified HTTP response may set the FIN flag in the packet to close the TCP connection. The body of the modified HTTP response may include the directions to download a script, as described above.

The edge router 230 may also send a message to the website server 260 to reset the TCP connection. For example, the edge router 230 may send a packet having the RST flag set. Accordingly, the website server 260 may process the packet as if the user device 210 had ended the connection.

In step 427, the browser on the user device 210 may determine whether scripts are enabled. If the user device 210 is not configured to run scripts, the user device may refresh the webpage and receive the original HTTP response. Afterwards, the method 400 may end. If the user device 210 is configured to run scripts, the method 400 may proceed to step 430.

In step 430, the user device 210 may send an HTTP GET request for the notification script identified in the modified HTTP response. The method 400 may be transparent to the user device 210. Because the modified HTTP response may appear to be the requested HTTP response from the website server 260, the user device 210 may send the HTTP GET request as instructed by the modified HTTP response.

In step 435, the notification server 280 may select a notification to provide to the user device 210. The notification server 280 may select the notification based on the requested URL including any parameters such as subscriber ID, subscriber IP address, and parameters from the policy server 250. The notification server 280 may use the reference to the previous HTTP GET request to construct a notification script that loads both the notification and the originally requested content. The notification script may use any method of displaying the notification and not be limited to use of a single method. For example, the notification server may use an overlay to display notifications to some user devices 210 and use a banner to display notifications to other user device 210.

In step 440, the notification server 280 may send the notification script to the user device 210 in response to the HTTP GET request. The user device 210 may execute the notification script to perform steps 445, 455, and 465.

In step 445, the user device may request the content of the original webpage from the website server 260, or any other server where the webpage content is stored. In step 450, the website server 260 or other service may send the requested content to the user device.

In step 455, the user device 210 may request additional notification content elements from the notification server. The user device 210 may also include a reference to the previous HTTP GET request when requesting notification elements. In various embodiments, all required notification elements may be included within the script and steps 255 and 260 may not be performed. In step 460, the notification server 280 may send the additional notification content elements to the user device 210. The browser of the user device 210 may display the content elements of the original webpage and the notification according to the script. The browser may give priority to rendering the original content over rendering the notification.

In step 465, the user device 210 may send a confirmation message to the notification server 280 indicating whether the browser of the user device 210 successfully displayed the notification. The confirmation message may be positive or negative and indicate other relevant result information. The confirmation message may use either an HTTP GET command or an HTTP POST command. In step 470, the notification server 280 may perform accounting and reporting of the notification. The notification server 280 may keep an internal record of whether the notification was successfully displayed by the browser on the user device. The notification server 280 may track statistics of successful notification and use the information to improve the success rate of notifications.

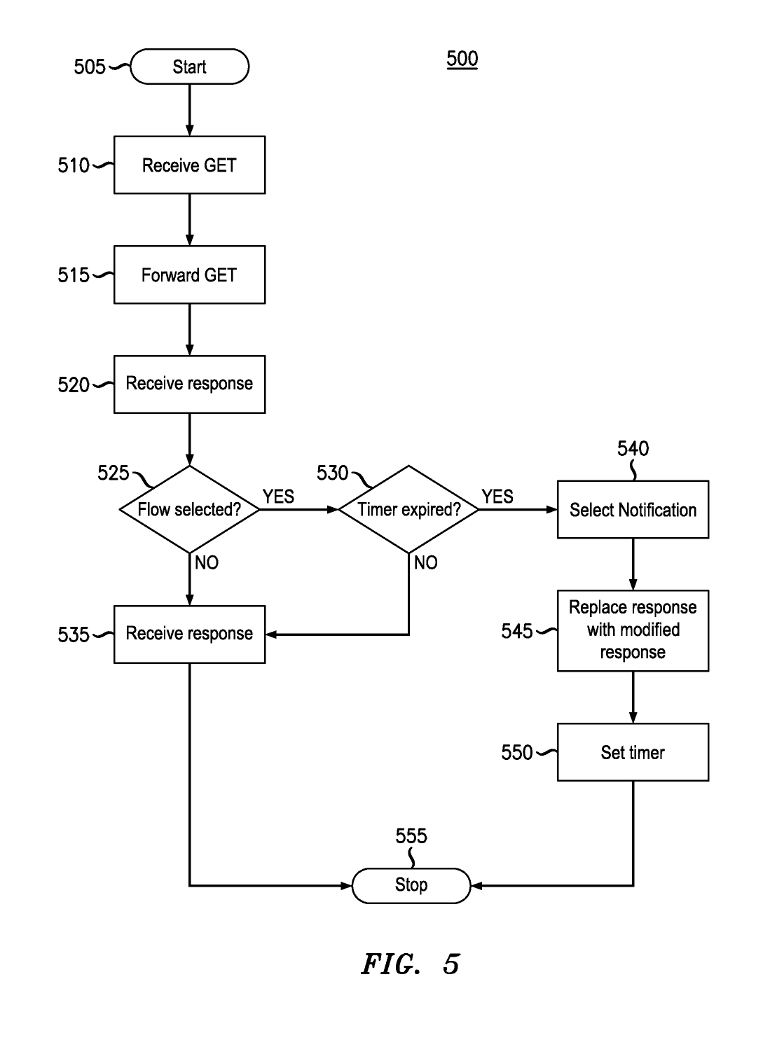

FIG. 5 illustrates a flowchart showing an exemplary method 500 performed by an edge router 230. It should be apparent that an edge router 230 may receive numerous messages and may perform method 500 regarding various groups of messages. The edge router 500 may simultaneously perform method 500 for multiple subscribers at different steps of the method. The method 500 may begin at step 505 and proceed to step 510. In step 510, the edge router 230 may receive an HTTP GET request. The edge router 230 may perform typical router operations on the request including determining a route for the request and applying routing policies such as a Quality of Service (QoS) for the subscriber. The edge router 230 may process the HTTP GET request using an AA-ISA card. The AA-ISA card may store the HTTP GET request or information included therein for further processing.

In step 515, the edge router 230 may forward the HTTP GET request towards the destination address of a website server 260.

In step 520, the edge router 230 may receive an HTTP response from the website server 260. In addition to typical router processing of the HTTP response, the edge router 230 may process the HTTP response using the AA-ISA card.

In step 525, the edge router 230 may determine whether to select the HTTP flow including the HTTP GET request and HTTP response for notification. As will be described in further detail below, the edge router 230 may apply selection criteria to both the HTTP GET request and the HTTP response. The edge router 230 may use an AA-ISA having deep packet inspection (DPI) capability to analyze layers 4-7 of the OSI model. The edge router 230 may apply the flow selection criteria to the HTTP GET request when it arrives in step 510. Accordingly, edge router 230 may determine not to select a flow based on only the HTTP GET request. If the edge router does not select the flow for notification, the method 500 may proceed to step 535. If the edge router 230 selects the flow for notification, the method 500 may proceed to step 530.

In step 530, the edge router 230 may determine whether a time limit has expired for the subscriber. The edge router 230 may maintain a time stamp for each subscriber indicating when the last HTTP response was intercepted for providing a notification. The time limit may establish a minimum time that the edge router 230 may wait before intercepting another HTTP response. For example, the limit may indicate that at least five minutes must elapse before intercepting another response. It should be apparent that other lengths of time may be chosen. A minimum time limit may be based on the time required to finish presenting a notification to a user device. The use of a time limit may prevent looping of notification messages and other errors which may otherwise provide a negative user experience. If the time limit has expired, the method 500 may proceed to step 540. If the time limit has not expired, the method 500 may proceed to step 535.

The edge router 230 may be configured with selection criteria for selecting specific types of flows that may provide useful opportunities for providing a notification to a subscriber. For example, the selection criteria may select requests for top-level webpages. Such webpages may be accessed near the start of a user's web experience. It may also be easier to insert a notification into such webpages without negatively affecting the user's experience.

In step 535 the edge router 230 may forward the original HTTP response to the user device 210 without modification. Accordingly, the user device 210 may view the webpage as requested. The method may then proceed to step 555, where the method ends.

In step 540, the edge router 230 may select a notification to provide to the subscriber. The notification may be selected based on information received from a policy server 250. In various embodiments, the edge router 230 may be configured to provide notifications from different notification servers. The edge router 230 may select the appropriate notification server for providing the notification. The edge router 230 may also be able to select a notification by providing a different URL for different scripts from the same notification server. The edge router 230 may also select a notification by providing different parameters to the notification server with the URL.

In step 545, the edge router 230 may replace the HTTP response with a modified response. The edge router 230 may generate a modified response instructing the user device to request a script located at the notification server 280. The modified response may appear as if it was sent from the edge router 230. Because the edge router 230 is actually located between the user device 210 and the website server 260, the edge router 230 may intercept the original HTTP response and replace it with a modified HTTP response without either the user device 210 or website server 260 being aware.

In step 550, the edge router 230 may measure the time since providing a notification. Edge router 230 may measure the time on a per subscriber or per device basis. For example, edge router 230 may store a timestamp of the last modified HTTP response sent to each subscriber. The method 500 may then proceed to step 555, where the method 500 ends.

According to the foregoing, various exemplary embodiments provide for a network service provider to send HTTP notifications to a user device. In particular, by using an in-line edge router to intercept particular HTTP flows, the network service provider may flexibly provide effective notifications.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a router, the method comprising:
receiving a HTTP GET request from a user device;
forwarding the HTTP GET request;
receiving a response to the HTTP GET request;
determining whether to intercept the response based on flow selection criteria; and
replacing the response with a modified response including a command to execute a script stored on a notification server.

2. The method of claim 1 further comprising:
determining whether a minimum time period has elapsed since intercepting a response; and
forwarding the modified response to a user device responsive to the time period being elapsed.

3. The method of claim 1, wherein the flow selection criteria indicate an initial request for a top-level webpage.

4. The method of claim 1, wherein the flow selection criteria include characteristics of both the HTTP GET request and the response.

5. The method of claim 1, wherein the method is performed by an inline subscriber edge router.

6. The method of claim 1, wherein the step of replacing the response with a modified response comprises adding an address of a script to the response.

7. The method of claim 6, wherein the address of the script is parameterized with subscriber information provided by a policy server.

8. The method of claim 1, wherein the modified response indicates that a connection established by the HTTP GET request should be closed.

9. A router comprising:
a plurality of line cards interconnected by a backplane, the plurality of line cards receiving communication packets and forwarding the packets towards a destination; and
an application assurance card connected to the backplane and configured to detect application traffic flows among the communication packets, wherein the application assurance card is further configured to:
identify an HTTP session comprising a HTTP GET request and a matching response from among the packets;
determine whether the HTTP session meets selection criteria; and
modify the matching response to include a command to execute a script stored on a notification server responsive to the HTTP session meeting the selection criteria.

10. The router of claim 9, wherein the router is an edge router located between a user device that sent the HTTP GET request and a server that sent the matching response.

11. The router of claim 9, wherein the application assurance card is further configured to ensure that a minimum time period has elapsed between modifying a matching response for a subscriber.

12. The router of claim 9, wherein the application assurance card is configured to modify the matching response by adding an address of a script to the response.

13. The router of claim 12, wherein the address of the script is parameterized with subscriber information provided by a policy server.

14. The router of claim 9, wherein the selection criteria are configured to select flows for a request for a top-level webpage.

15. A non-transitory machine-readable storage medium encoded with instructions executable by a processor, the machine-readable storage medium comprising:
instructions for receiving a HTTP GET request from a user device;
instructions for forwarding the HTTP GET request;
instructions for receiving a response to the HTTP GET request;
instructions for determining whether to intercept the response based on flow selection criteria; and
instructions for replacing the response with a modified response including an address of a script stored on a notification server.

16. The non-transitory machine-readable storage medium of claim 15, further comprising instructions for sending a modified response to a user device and instructions for measuring a time period since the modified response was sent.

17. The non-transitory machine-readable storage medium of claim 16, further comprising:
instructions for receiving a second HTTP GET request from the user device;
instructions for determining whether a minimum time period has elapsed since the modified response was sent; and
instructions for modifying a response to the second HTTP GET request responsive to the time period being elapsed.

18. The non-transitory machine-readable storage medium of claim 15, wherein the address of the script is parameterized with subscriber information provided by a policy server.

19. The non-transitory machine-readable storage medium of claim 15, wherein the flow selection criteria include characteristics of both the HTTP GET request and the response.

20. The non-transitory machine-readable storage medium of claim 15, wherein the modified response indicates that a connection established by the HTTP GET request should be closed and the modified response should not be cached.

21. The non-transitory machine-readable storage medium of claim 15 operably connected to a processor of a router, wherein the router receives all communication packets transmitted between a user device and a web site server.
